(19) United States
(12) Patent Application Publication
(10) Pub. No.: US 2008/0000372 A1
(43) Pub. Date: Jan. 3, 2008

(54) Printing device system, patterning method using the same, and method of fabricating liquid crystal display device using the same

(76) Inventors: Chul Ho Kim, Gyeonggi-do (KR); Tae Young Oh, Gyeonggi-do (KR); Choon Ho Park, Gyeonggi-do (KR)

Correspondence Address: MORGAN LEWIS & BOCKIUS LLP, 1111 PENNSYLVANIA AVENUE NW, WASHINGTON, DC, 20004, US

(21) Appl. No.: 11/819,826

(22) Filed: Jun. 29, 2007

(30) Foreign Application Priority Data
Jun. 30, 2006 (KR) P2006-060430

(51) Int. Cl. B41N 1/00; B41M 1/10

(52) U.S. Cl. 101/395; 101/170

(57) ABSTRACT

A printing device system, a patterning method and a method of fabricating an LCD device are disclosed, the printing device system comprising a printing plate provided with protruding and groove patterns, wherein hydrophobic layers are formed in the groove patterns, to prevent a defective pattern even though a blanket being swollen due to a solvent included in a pattern material is in contact with the groove patterns of the printing plate.

This application claims the benefit of the Korean Patent Application No. P2006-60430, filed on Jun. 30, 2006, which is hereby incorporated by reference as if fully set forth herein.

### BACKGROUND OF THE INVENTION

1. Field of the Invention

The present invention relates to a liquid crystal display (LCD) device, and more particularly, a patterning method of an LCD device using a printing apparatus.

2. Discussion of the Related Art

Generally, an LCD device is comprised of lower and upper substrates, and a liquid crystal layer formed between the lower and upper substrates. The lower substrate includes a thin film transistor and a pixel electrode, and the upper substrate includes a light-shielding layer, a color filter layer and a common electrode.

The LCD device includes various elements formed by repeated manufacturing processes. Especially, a photolithography process is used so as to form the elements in various shapes. However, the photolithograph process necessarily uses a mask of a predetermined pattern, whereby the fabricating cost is increased. In addition, since the photolithography process requires exposure and development, it causes the complicated process and the increasing fabricating time.

To overcome these problems of the photolithography process, a new patterning method has been developed, for example, a printing method using a printing roll and a printing plate.

Hereinafter, a related art printing method will be explained with reference to the accompanying drawings.

FIGS. 1A to 1C are cross section views illustrating a related art printing method.

First, as shown in FIG. 1A, a pattern material 20 is applied to a printing roll 30 through a printing nozzle 10, whereby the printing roll 30 is coated with the pattern material 20. At this time, a blanket 35 is adhered to the outer surface of the printing roll 30. That is, the blanket 35 of the printing roll 30 is coated with the pattern material 20.

The blanket 35 requires the good adherence to the printing roll 30, and also requires the anti-deformation properties on the printing process. To satisfy these requirements, the blanket 35 is generally formed of Si-based resin.

Referring to FIG. 1B, the printing roll 30 is rolled on a printing plate 40 having a plurality of protruding patterns 46 and groove patterns 43. As a result, some of the pattern material 20a are transcribed on the protruding patterns 46 of the printing plate 40, and the remaining pattern material 20b forms the predetermined pattern on the blanket 35 of the printing roll 30.

Referring to FIG. 1C, the printing roll 30 is rolled on a substrate 50, whereby the remaining pattern material 20b of the printing roll 30 is transcribed on the substrate 50, thereby forming the desired pattern on the substrate 50.

For the printing method, it is unnecessary to carry out the exposure and development of photolithography. Thus, the printing method has the low fabrication cost and the simplified process, so that the printing method is suitable for the mass-production.

According as the pattern formation of the printing method is performed repeatedly, a solvent of pattern material 20 is absorbed into the blanket 35 adhered to the outer surface of the printing roll 30. Thus, the blanket 35 may be swollen. If the blanket 35 is swollen, it is difficult to form a precise pattern.

That is, as shown in FIG. 2A, when the blanket 35 of the printing roll 30 coated with the pattern material 20 is rolled on the printing plate 40 having the protruding patterns 46 and groove patterns 43, if the blanket 35 is swollen, the pattern material 20 can be brought into contact with the groove patterns 43 of the printing plate 40. In this case, as shown in FIG. 2B, some 20a of the pattern material are transcribed on the protruding patterns 46, and others 20b are transcribed on the groove patterns 43. Thus, it is difficult to realize the desired pattern in the pattern material 20c remaining on the blanket 35 of the printing roll 30, and the pattern material is not formed in “A”, whereby the precise pattern formation is impossible.

### SUMMARY OF THE INVENTION

Accordingly, the present invention is directed to a printing device, a patterning method using the same, and a method of fabricating an LCD device using the same that substantially obviates one or more problems due to limitations and disadvantages of the related art.

An object of the present invention is to provide a printing device system to prevent a defective pattern caused by a blanket of a printing roll being swollen due to a solvent included in a pattern material.

Another object of the present invention is to provide a patterning method to prevent a defective pattern caused by a blanket of a printing roll being swollen due to a solvent included in a pattern material.

Another object of the present invention is to provide a method of fabricating an LCD device to prevent a defective pattern.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a printing device system comprises a printing plate including protruding and groove patterns, wherein hydrophobic layers are formed in the groove patterns.

In another aspect, a patterning method comprises coating a blanket adhered to an outer surface of a printing roll with a pattern material; rolling the printing roll on a printing plate including protruding and groove patterns, the groove patterns provided with hydrophobic layers, to transcribe the pattern material on the protruding patterns of the printing plate, and to form a predetermined pattern on the printing roll by the remaining pattern material; and rolling the printing material on a substrate to transcribe the predetermined pattern on the substrate.

In another aspect, a method of fabricating an LCD device comprises preparing first and second substrates; and forming a liquid crystal layer between the first and second substrates, wherein preparing the first substrate includes forming a pattern on the first substrate, and forming the pattern on the substrate is performed by the patterning method.

For the printing device system according to the present invention and the patterning method using the same, the hydrophobic layers are formed in the groove patterns of the printing plate. Thus, even though the blanket of the printing roll, which is swollen by the solvent included in the pattern material, is undesirably brought into contact with the groove patterns of the printing plate, the pattern material is not transcribed on the groove patterns since the hydrophobic layers formed in the groove patterns prevent the pattern material coated on the blanket from being transcribed on the groove patterns of the printing plate, thereby preventing the defective pattern.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1C are cross section views illustrating a related art printing method;

FIGS. 2A and 2B are cross section views explaining problems of a related art printing method;

FIG. 3 is a schematic view illustrating a printing device system according to one preferred embodiment of the present invention;

FIG. 4 is a cross section view illustrating a printing plate according to one preferred embodiment of the present invention; and

FIGS. 5A to 5C are cross section views illustrating a patterning method according to one preferred embodiment of the present invention.

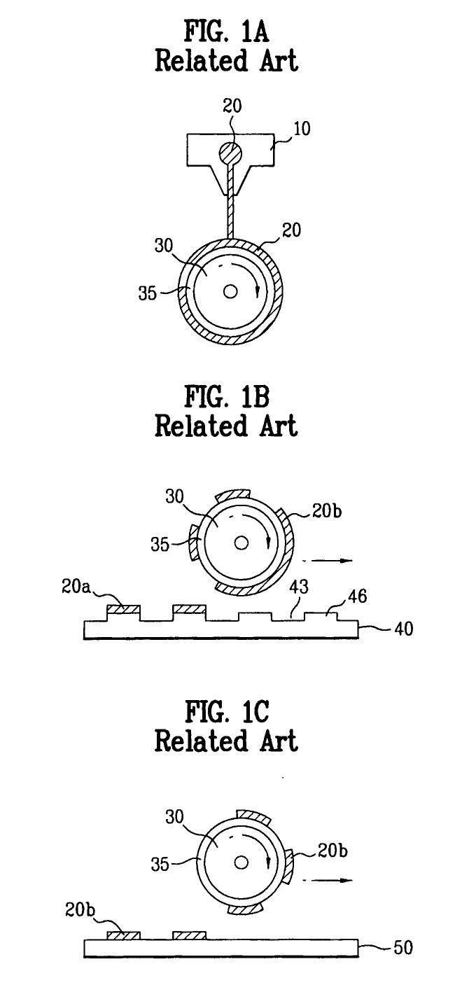

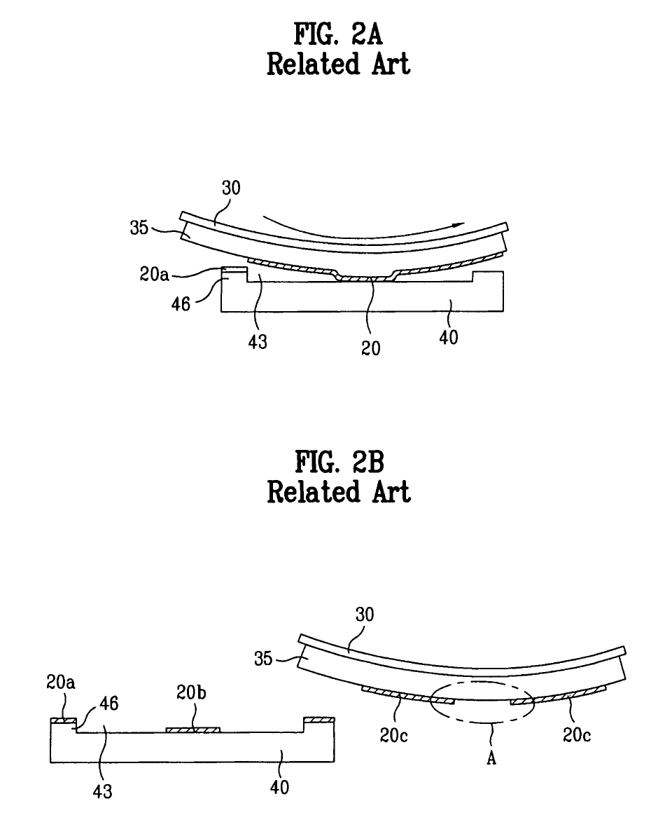

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a printing device system according to the present invention, a patterning method using the same and a method of fabricating an LCD device using the same will be described with reference to the accompanying drawings.

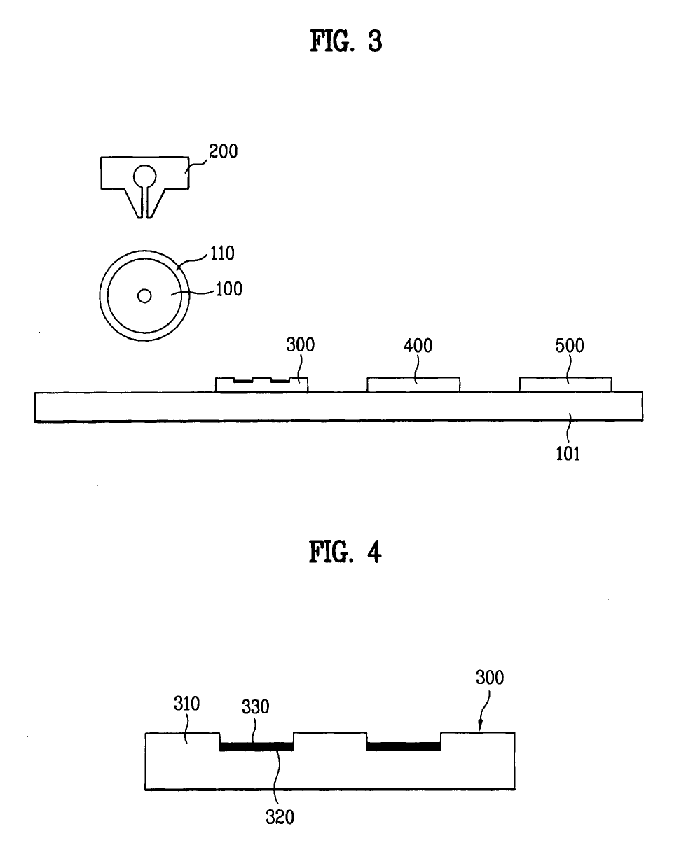

FIG. 3 is a schematic view illustrating a printing device system according to one preferred embodiment of the present invention. FIG. 4 is a cross section view of illustrating a printing plate according to one preferred embodiment of the present invention.

As shown in FIG. 3, the printing device system according to one preferred embodiment of the present invention is comprised of a rail 101, a printing roll 100, a printing nozzle 200, a printing plate 300, and a substrate 400. At this time, a blanket 110 is adhered to the outer surface of the printing roll 100. The printing roll 100 is moved along the rail 101 through the printing nozzle 200, the printing plate 300 and the substrate 400, whereby a predetermined pattern is formed on the substrate 400. The printing nozzle 200 supplies a pattern material to the printing roll 100.

Also, the printing plate 300 is comprised of a plurality of protrusions. As the printing roll 100 is rolled on the printing plate 300, some of the pattern material is transcribed on the protrusions of printing plate 300, whereby a desired pattern remains on the printing roll 100. There is a cleaning device 500 to remove some of the pattern material transcribed on the protrusions of printing plate 300 after rolling the printing roll 100 on the printing plate 300.

As shown in FIG. 4, the printing plate 300 includes a plurality of protruding patterns 310 and groove patterns 320, wherein the groove patterns 320 are provided with hydrophobic layers 330. The hydrophobic layers 330 may be formed of metal.

The hydrophobic layers 330 are formed by a photolithograph process. This will be explained as follows.

A substrate for the printing plate 300 is selectively etched to form the groove patterns 320. A hydrophobic material is formed on the substrate including the groove patterns 320, and a photoresist layer is formed on the hydrophobic material. The photoresist layer is patterned to remain on the groove patterns 320 by the exposure and development processes. The hydrophobic material is etched by using the patterned photoresist layer as a mask to form the hydrophobic layers 330 on the groove patterns 320.

Even though the blanket 110 of the printing roll 100, which is swollen by the solvent included in the pattern material, is undesirably brought into contact with the groove patterns 320 of the printing plate 300, the pattern material is not transcribed on the groove patterns 320 since the hydrophobic layers 330 are formed in the groove patterns 320 of the printing plate 300. This will be explained as follows.

The printing plate 300 is generally formed of a glass material having the hydrophilic properties. Accordingly, the protruding patterns 310 of the printing plate 300 have the hydrophilic properties. In the meantime, a surface energy in the material having the hydrophilic properties is larger than a surface energy in the material having the hydrophobic properties. In this case, the surface energy indicates the energy required for the unit area so as to form the interface between the solid phase and the gas phase. If the predetermined material has the small surface energy, it means that the predetermined material and the air form the interface with easiness, so that the predetermined material is not adhered to another material. Meanwhile, if the predetermined material has the large surface energy, the predetermined material is easily adhered to another material.

The surface energy in the protruding patterns 310 of the printing plate 300 is larger than the surface energy in the hydrophobic layers 330 of the groove patterns 320 of the printing plate 300. Thus, the pattern material is adhered not to the hydrophobic layers 330 formed in the groove patterns 320 of the printing plate 300 but to the protruding patterns 310 of the printing plate 300. Eventually, even though the blanket of the printing roll, which is swollen by the solvent included in the pattern material, is undesirably brought into contact with the groove patterns of the printing plate, the pattern material is not transcribed on the groove patterns since the hydrophobic layers formed in the groove patterns prevent the pattern material coated on the blanket from being transcribed on the groove patterns of the printing plate.

Hereinafter, a patterning method according to the present invention will be explained with reference to the accompanying drawings.

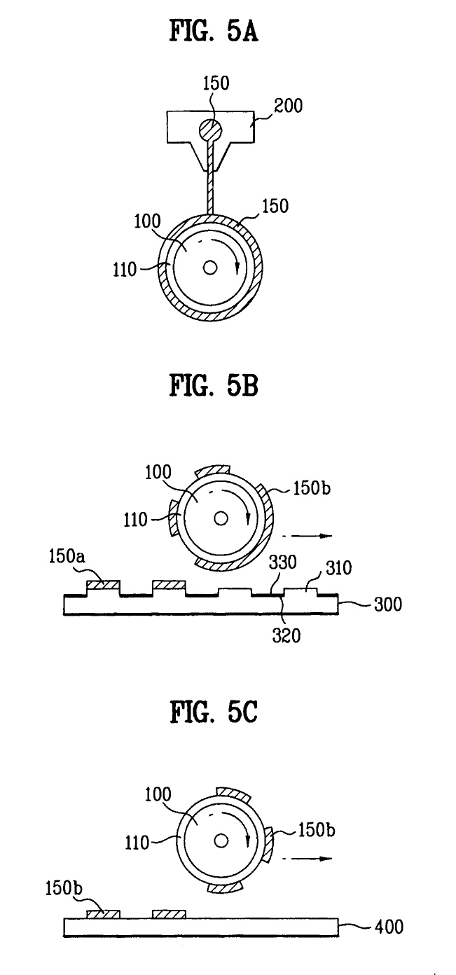

FIGS. 5A to 5C are cross section views illustrating a patterning method according to one preferred embodiment of the present invention.

First, as shown in FIG. 5A, a pattern material 150 is applied to a blanket 110 of a printing roll 100 through a printing nozzle 200. Thus, the blanket 110 of the printing roll 100 is coated with the pattern material 150.

Then, as shown in FIG. 5B, the printing roll 100 is rolled on a printing plate 300, whereby some 150a of the pattern material is transcribed on protruding patterns 310 of the printing plate 300, and a predetermined pattern 150b is formed on the printing roll 100 by the remaining pattern material.

As shown in FIG. 4, the printing plate 300 includes the protruding patterns 310 and groove patterns 320, wherein the groove patterns 320 are provided with hydrophobic layers 330. The printing plate 300 is the same as the previously explained one, whereby the detailed explanation for the printing plate 300 will be omitted.

As shown in FIG. 5C, the printing roll 100 is rolled on a substrate 400, whereby the pattern 150b is transcribed on the substrate 400.

After completing the patterning process, there is a step of cleaning the printing plate 300.

Hereinafter, a method of fabricating an LCD device according to the present invention will be explained with reference to the accompanying drawings.

First, first and second substrates are prepared.

The first substrate includes a black matrix layer to prevent the light leakage on a transparent substrate; a color filter layer formed on the black matrix layer; and a common electrode formed on the color filter layer.

The second substrate includes a thin film transistor comprised of a gate electrode, a semiconductor layer, and source and drain electrodes formed on a transparent substrate; and a pixel electrode connected to the drain electrode of the thin film transistor.

On the process of preparing the first substrate, the steps of forming the black matrix layer and the color filter layer use the above-mentioned patterning method.

Then, a liquid crystal layer is formed between the first and second substrates.

Forming the liquid crystal layer may use a liquid crystal injection method or a liquid crystal dispensing method.

For the liquid crystal injection method, a sealant including an inlet is formed in any one of the first and second substrates, and then the first and second substrates are bonded to each other. After that, liquid crystal is injected to the space between the first and second substrates through the inlet.

For the liquid crystal dispensing method, a sealant having no inlet is formed in any one of the first and second substrates, and then liquid crystal is dispensed on any one of the first and second substrates, and the first and second substrates are bonded to each other.

As mentioned above, the printing device system according to the present invention, the patterning method and the method of fabricating the LCD device using the same have the following advantages.

For the printing device system according to the present invention and the patterning method using the same, the hydrophobic layers are formed in the groove patterns of the printing plate. Thus, even though the blanket of the printing roll, which is swollen by the solvent included in the pattern material, is undesirably brought into contact with the groove patterns of the printing plate, the pattern material is not transcribed on the groove patterns since the hydrophobic layers formed in the groove patterns prevent the pattern material coated on the blanket from being transcribed on the groove patterns of the printing plate, thereby preventing the defective pattern.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A printing device system comprising:
a printing plate including protruding and groove patterns; and
hydrophobic layers in the groove patterns.

2. The system of claim 1, wherein the protruding patterns of the printing plate have the hydrophilic properties.

3. The system of claim 1, wherein the hydrophobic layers have a surface energy which is smaller than that of the protruding patterns of the printing plate.

4. The system of claim 1, wherein the hydrophobic layers are formed of metal.

5. The system of claim 1, further comprising:
a printing roll to transcribe some of a pattern material on the printing plate and to transcribe the other of the pattern material on a substrate; and
a printing nozzle to supply the pattern material to the printing roll.

6. The system of claim 5, wherein the printing roll has a blanket adhered to the outer surface of the printing roll.

7. The system of claim 1, further comprising a cleaning device to clean the printing plate.

8. The system of claim 1, wherein the hydrophobic layers are formed by photolithograph process comprising steps of:
forming the groove patterns in a substrate for the printing plate;
forming a hydrophobic material on the substrate including the groove patterns;
forming a photoresist pattern on the hydrophobic material above the groove patterns; and
etching the hydrophobic material using the photoresist pattern as a mask to form the hydrophobic layers on the groove patterns.

9. A patterning method comprising:
coating a blanket adhered to an outer surface of a printing roll with a pattern material;
rolling the printing roll on a printing plate including protruding and groove patterns, the groove patterns provided with hydrophobic layers, to transcribe the pattern material on the protruding patterns of the printing plate, and to form a predetermined pattern on the printing roll by the remaining pattern material; and
rolling the printing material on a substrate to transcribe the predetermined pattern on the substrate.

10. The patterning method of claim 9, wherein coating the printing roll with the pattern material is performed with a printing nozzle.

11. The pattering method of claim 9, wherein the protruding patterns of the printing plate have the hydrophilic properties.

12. The patterning method of claim 9, wherein the hydrophobic layers have a surface energy which is lower than that of the protruding patterns of the printing plate.

13. The patterning method of claim 9, wherein the hydrophobic layers are formed of metal.

14. The patterning method of claim 9, further comprising cleaning the printing plate.

15. A method of fabricating an LCD device comprising:
preparing first and second substrates; and
forming a liquid crystal layer between the first and second substrates,
wherein preparing the first substrate includes forming a pattern on the first substrate, and forming the pattern on the substrate is performed by the patterning method of any one of claims 9 to 14.

16. The method of claim 15, wherein the pattern corresponds to a black matrix layer or a color filter layer.

17. The method of claim 15, wherein forming the liquid crystal layer comprises:
forming a sealant including an inlet in any one of the first and second substrates;
bonding the first and second substrates to each other; and
injecting liquid crystal into the space between the first and second substrates through the inlet.

18. The method of claim 15, wherein forming the liquid crystal layer comprises:
forming a sealant having no inlet in any one of the first and second substrates;
dispensing liquid crystal on any one of the first and second substrates; and
bonding the first and second substrates to each other.
